(19) United States
(12) Patent Application Publication
(10) Pub. No.: US 2010/0169548 A1
(43) Pub. Date: Jul. 1, 2010

(54) MEMORY CARD AND METHOD FOR CONTROLLING MEMORY CARD

(75) Inventor: Tomohiro KANDA, Saitama-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/537,160

(22) Filed: Aug. 6, 2009

(30) Foreign Application Priority Data
Sep. 11, 2008 (JP) 2008-233548

(51) Int. Cl. G06F 12/00; H04B 7/00; G06F 13/00

(52) U.S. Cl. 711/103; 455/41.2; 711/154; 711/E12.002

(57) ABSTRACT

According to one embodiment, a memory card configured to be installed in and removed from a card slot formed in an electronic apparatus, the memory card includes a memory section configured store at least one file, a close-proximity wireless transfer section configured to perform close-proximity wireless transfer, and a controller configured, every time communication between the close-proximity wireless transfer section and a different close-proximity wireless transfer device is enabled, to execute a process for using the close-proximity wireless transfer section to transmit the files stored in the memory section to the different close-proximity wireless transfer device.

### CROSS-REFERENCE TO RELATED APPLICATIONS

This application is based upon and claims the benefit of priority from Japanese Patent Application No. 2008-233548, filed Sep. 11, 2008, the entire contents of which are incorporated herein by reference.

### BACKGROUND

1. Field

One embodiment of the invention relates to a memory card having a close-proximity wireless transfer function and a method for controlling the memory card.

2. Description of the Related Art

In recent years, memory cards containing a wireless LAN function (IEEE 802.11b/g) have been commercially available (“Eye-Fi Share 2 GB Wireless SD Card makes it easy to save photos and share them to the web”, [online], Eye-Fi, [searched on Jul. 7, 2009], see <URL:http://www.eye.fi/cards/share.html> on the Internet).

When a memory card with the wireless LAN function is used as a memory device for a digital camera, a file of a photographed video can be automatically transferred to a personal computer or the like having the wireless LAN function.

A close-proximity wireless transfer technique with a transmission distance of at most 3 cm has been developed. The close-proximity wireless transfer involves an extremely short transmission distance. Thus, relevant apparatuses are normally contacted with each other to allow a file to be transmitted between the apparatuses.

In the close-proximity wireless transfer, the operation of bringing the apparatuses into contact with each other starts a file transmission operation. Thus, there has been a demand to provide a user-friendly user interface that controls file transmission by attaching certain significance to the user's action of bringing the apparatuses into contact with each other (allowing the apparatuses to perform close-proximity wireless transfer).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the system configuration of a digital camera (electronic apparatus), a memory card, and a personal computer according to an embodiment of the present invention;

FIG. 2 is an exemplary flowchart showing the procedure of processing in a communication mode in which files recently written to the memory card are received;

FIG. 3 is an exemplary flowchart showing the procedure of processing in a communication mode in which files recently read from the memory card through read accesses are received;

FIG. 4 is an exemplary diagram showing that a command is displayed on each of two display devices of respective digital cameras;

FIG. 5 is an exemplary diagram showing an example of transition of the communication mode; and

FIG. 6 is an exemplary flowchart showing the procedure of processing for carrying out the transition.

### DETAILED DESCRIPTION

Various embodiments according to the invention will be described hereinafter with reference to the accompanying drawings. In general, according to one embodiment of the invention, a memory card configured to be installed in and removed from a card slot formed in an electronic apparatus, the memory card comprises a memory section configured store at least one file, a close-proximity wireless transfer section configured to perform close-proximity wireless transfer, and a controller configured, every time communication between the close-proximity wireless transfer section and a different close-proximity wireless transfer device is enabled, to execute a process for using the close-proximity wireless transfer section to transmit the files stored in the memory section to the different close-proximity wireless transfer device.

An embodiment of the present invention will be described with reference to the drawings.

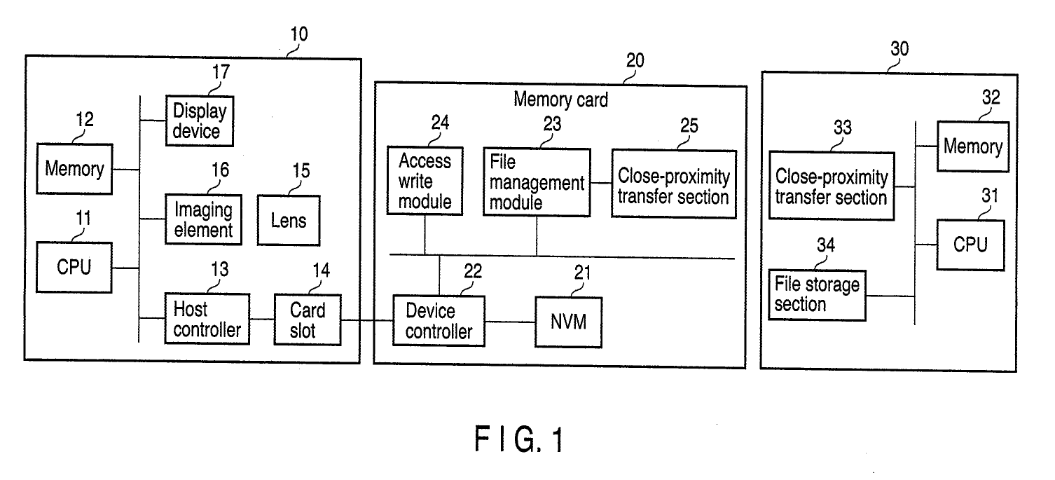

FIG. 1 is a block diagram showing the system configuration of a digital camera having a close-proximity wireless transfer function according to a first embodiment of the present invention and a card slot 14 through which a memory card 20 can be inserted and removed, and a computer having the close-proximity wireless transfer function and a memory device.

As shown in FIG. 1, the digital camera 10 has a lens 15, an imaging element 16, a display device 17, CPU 11, a memory 12, a host controller 13, and a card slot 14.

CPU 11 is a processor that controls the operation of the digital camera 10. CPU 11 executes firmware loaded into the memory 12.

The host controller 13 controls communication with the memory card 20 inserted into the card slot 14. The host controller 13 communicates with the memory card 20 to execute a process for writing a file to the memory card 20 or reading a file stored in the memory card 20.

The imaging element 16 converts an image formed in an imaging area in the imaging element 16 via the lens 15, into data. The image converted into data is displayed on a display screen of a display device 17. A video file stored in the memory card 20 is displayed on the display screen of the display device 17.

The memory card 20 has a nonvolatile memory (NVM) 21, a device controller 22, a file management module 23, an access write module 24, and a close-proximity wireless transfer section 25.

Files are stored in the nonvolatile memory (NVM) 21, serving as a memory section. The device controller 22 controls communication with the digital camera 10. The file management module 23 has the function of recognizing the files stored in the nonvolatile memory 21. The file management module 23, serving as a control section, has the function of controlling file transmission and reception based on the close-proximity wireless transfer. The access write module 24 has the function of holding history information on accesses (read/write) performed on the files stored in the nonvolatile memory 21 by the digital camera 10.

The close-proximity wireless transfer section 25 performs close-proximity wireless transfer. The close-proximity wireless transfer between the close-proximity wireless transfer section 25 and a different close-proximity wireless transfer section (33) is performed on a peer to peer basis. Communicable distance is, for example, 3 cm. The close-proximity wireless transfer between the close-proximity wireless transfer section 25 and the different close-proximity wireless transfer section (33) is enabled only when the distance between the close-proximity wireless transfer section 25 and the different close-proximity wireless transfer section (33) decreases to at most a predetermined value (for example, 3 cm). For example, Transfer JET can be used as a close-proximity wireless transfer scheme. Transfer JET is a close-proximity wireless transfer scheme utilizing UWB, and allows high-speed data transfer to be achieved.

The computer 30 has CPU 31, a memory 32, a file storage section 34, and a close-proximity wireless transfer section 33.

CPU 31 is a processor that controls the operation of the computer 30. CPU 31 executes an operating system (OS) and various application programs loaded into the memory 32.

The close-proximity wireless transfer section 33 is a device that can communicate with the close-proximity wireless transfer section 25 mounted in the memory card 20. The file storage section 34 is composed of, for example, a hard disk drive and can store files transferred from the memory card 20 by the close-proximity wireless transfer.

An application program (file transfer program) executed by the computer 30 sets the close-proximity wireless transfer section 33 and the close-proximity wireless transfer section 25 of the memory card 20 in any of the following communication modes.

1. Reception only (the close-proximity wireless transfer section 25 of the memory card 20 transmits a file to the close-proximity wireless transfer section 33).

2. Transmission only (the close-proximity wireless transfer section 33 transmits a file to the close-proximity wireless transfer section 25 of the memory card 20).

3. All files absent from the computer are received (the close-proximity wireless transfer section 25 of the memory card 20 transmits the files to the close-proximity wireless transfer section 33).

4. All files absent from the memory card are transmitted (the close-proximity wireless transfer section 33 transmits the files to the close-proximity wireless transfer section 25 of the memory card 20).

5. Files recently written to the memory card are received (the files are transferred one by one starting with the most recently written one) (the close-proximity wireless transfer section 25 of the memory card 20 transmits the files to the close-proximity wireless transfer section 33).

6. Files recently read from the memory card through read accesses are received (the files are transferred one by one starting with the file subjected to the most recent read access) (the close-proximity wireless transfer section 25 of the memory card 20 transmits the files to the close-proximity wireless transfer section 33).

The communication modes will be described.

In “1. Reception only”, the file transfer program sets the close-proximity wireless transfer section 33 in a mode for reception of files. The file transfer program sets the file management module 23, via the close-proximity wireless transfer sections 33 and 25, in a transmission mode in which the file management module 23 transmits all the files stored in the nonvolatile memory 21.

In “2. Transmission only”, the file transfer program sets the close-proximity wireless transfer section 33 in a mode for transmission of files. Then, the file transfer program sets the file management module 23 in a mode for reception of files via the close-proximity wireless transfer sections 33 and 25. The file transfer program transmits a file set by the user to the memory card 20 via the close-proximity wireless transfer sections 33 and 25. The access write module 24 stores the received file in the nonvolatile memory 21.

In “3. All files absent from the computer are received”, the file transfer program sets the close-proximity wireless transfer section 33 in the mode for reception of files. The file transfer program sets the file management module 23, via the close-proximity wireless transfer sections 33 and 25, in a transmission mode in which the file management module 23 transmits all files stored in the nonvolatile memory 21 and untransmitted to the computer 30. The file management module 23 refers history information managed by the access write module 24. The file management module 23 then transmits all of the files untransmitted to the computer 30.

In “4. All files absent from the memory card are received”, the file transfer program sets the close-proximity wireless transfer section 33 in the mode for transmission of files. The file transfer program sets the file management module 23 in the mode for reception of files via the close-proximity wireless transfer sections 33 and 25. A folder associated with the memory card 20 is set in the file transfer program. The file transfer program stores transmission history information on files transmitted from the folder to the memory card 20, in the file storage section 34. The file transfer program refers the transmission history information to transmit all of those of the files in the folder associated with the memory card 20 which are untransmitted to the memory card 20, to the memory card 20 via the close-proximity wireless transfer sections 33 and 25. The file management module 23 stores the received files in the nonvolatile memory 21.

In “5. files recently written to the memory card are received”, the file transfer program sets the close-proximity wireless transfer section 33 in the mode for reception of files. Then, the file transfer program sets the file management module 23, via the close-proximity wireless transfer sections 33 and 25, in a transmission mode in which the file management module 23 transmits files recently written to the memory card. Every time the close-proximity wireless transfer is enabled, the file management module 23 sequentially transmits the files to the computer 30 starting with the most recently written one.

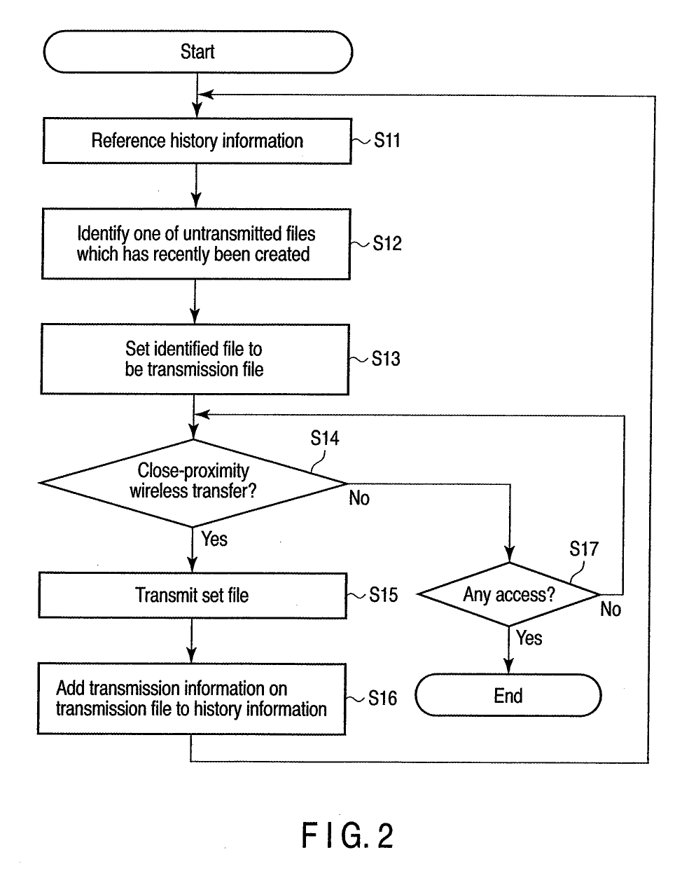

Processing on the memory card side in the communication modes will be described with reference to FIG. 2.

First, the file management module 23 refers the history information managed by the access write module 24 (step S11). Then, based on the referred history information, the file management module 23 identifies one of the untransmitted files which has recently been created (step S12). The file management module 23 sets the identified file to be a transmission file (step S13).

The file management module 23 inquires of the close-proximity wireless transfer section 25 whether or not the close-proximity wireless transfer between the close-proximity wireless transfer sections 25 and 33 is enabled. Upon receiving a response from the close-proximity wireless transfer section 25, the file management module 23 determines whether or not the response indicates that the close-proximity wireless transfer is enabled (step S14). If the file management module 23 determines that the close-proximity wireless transfer section is not enabled (No in step S14), the file management module 23 determines whether or not any of the files in the nonvolatile memory 21 has been accessed by the digital camera 10 (step S17). If the file management module 23 determines that none of the files in the nonvolatile memory 21 has been accessed (No in step S17), then a given time later, the file management module 23 inquires again of the close-proximity wireless transfer section 25 whether or not the close-proximity wireless transfer is enabled. The file management module 23 then executes the processing in step S14. Upon determining that a file has been accessed by the digital camera 10 (Yes in step S17), the file management module 23 terminates the processing.

Upon determining in step S14 that the close-proximity wireless transfer is enabled (Yes in step S14), the file management module 23 uses the device controller 22 and the close-proximity wireless transfer section 25 to transmit the file set in step S13 to the computer 30 (step S15). The file management module 23 then instructs the access write module 24 to add transmission information (transmission date and time, and destination) on the transmission file to the history information. The access write module 24 updates the history information (step S16). The above-described processing allows the files recently written to the memory card to be transmitted to the computer 30 one by one every time the close-proximity wireless transfer is enabled.

In “6. files recently read from the memory card 20 through read accesses are received”, the file transfer program sets the close-proximity wireless transfer section 33 in the mode for reception of files. The file transfer program then sets the file management module 23, via the close-proximity wireless transfer sections 33 and 25, in a transmission mode in which the file management module 23 transmits files recently read from the memory card (read accesses). The file management module 23 sequentially transmits the recently read files (read accesses) to the computer 30, every time the close-proximity wireless transfer is enabled.

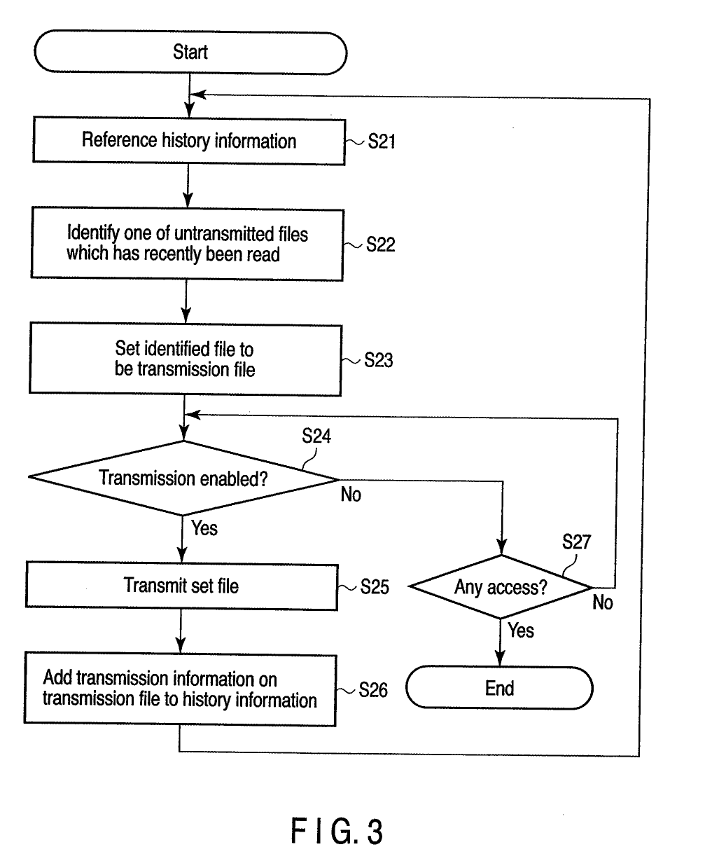

The processing on the memory card side in the communication mode will be described with reference to FIG. 3.

First, the file management module 23 refers the history information managed by the access write module 24 (step S21). Then, based on the referred history information, the file management module 23 identifies one of the untransmitted files which has recently been read (read access) (step S22). The file management module 23 sets the identified file to be a transmission file (step S23).

The file management module 23 inquires of the close-proximity wireless transfer section 25 whether or not the close-proximity wireless transfer between the close-proximity wireless transfer sections 25 and 33 is enabled. Upon receiving a response from the close-proximity wireless transfer section 25, the file management module 23 determines whether or not the response indicates that the close-proximity wireless transfer is enabled (step S24). If the file management module 23 determines that the close-proximity wireless transfer section is not enabled (No in step S24), the file management module 23 determines whether or not any of the files in the nonvolatile memory 21 has been accessed by the digital camera 10 (step S27). If the file management module 23 determines that none of the files in the nonvolatile memory 21 has been accessed (No in step S27), then a given time later, the file management module 23 inquires again of the close-proximity wireless transfer section 25 whether or not the close-proximity wireless transfer is enabled. The file management module 23 then executes the processing in step S24. Upon determining that a file has been accessed by the digital camera 10 (Yes in step S27), the file management module 23 terminates the processing.

Upon determining in step S24 that the close-proximity wireless transfer is enabled (Yes in step S24), the file management module 23 uses the device controller 22 and the close-proximity wireless transfer section 25 to transmit the file set in step S23 to the computer 30 (step S25). The file management module 23 then instructs the access write module 24 to add transmission information (transmission date and time, and destination) on the transmission file to the history information. The access write information 24 updates the history information (step S26). The above-described processing allows the files recently read from the memory card (read accesses) to be transmitted to the computer 30 one by one every time the close-proximity wireless transfer is enabled.

Instead of being explicitly set for the memory card 20 by the file transfer application executed by the computer 30, the mode may be automatically switched depending on the following operational status of the file transfer application.

If the file transfer application is displaying one video, the videos (files) recently written to the memory card 20 are sequentially transferred. Only one file is transferred and displayed on the computer 30.

If the file transfer application is displaying a list of videos, the memory card 20 transmits all files absent from the computer 30 (from a memory device containing a wireless function). The file transfer application updates a list of the videos (files) stored in the computer 30.

For example, as shown in FIG. 2, if the memory card 20 having the close-proximity wireless transfer function is used for communication, the reception side cannot explicitly specify the mode. In this case, the system may be made compatible with a signal mode as described below.

The memory card and the computer transfer all of files absent from the destination to each other.

In the memory card 20, the last accessed (read/write) file is detected. Then, according to the detected file, a transfer direction and contents to be transferred are determined, for example, whether to perform transmission or reception and which of the files to be transferred (the purpose of this operation is to allow apparatuses incompatible with close-proximity wireless transfer to communicate with each other).

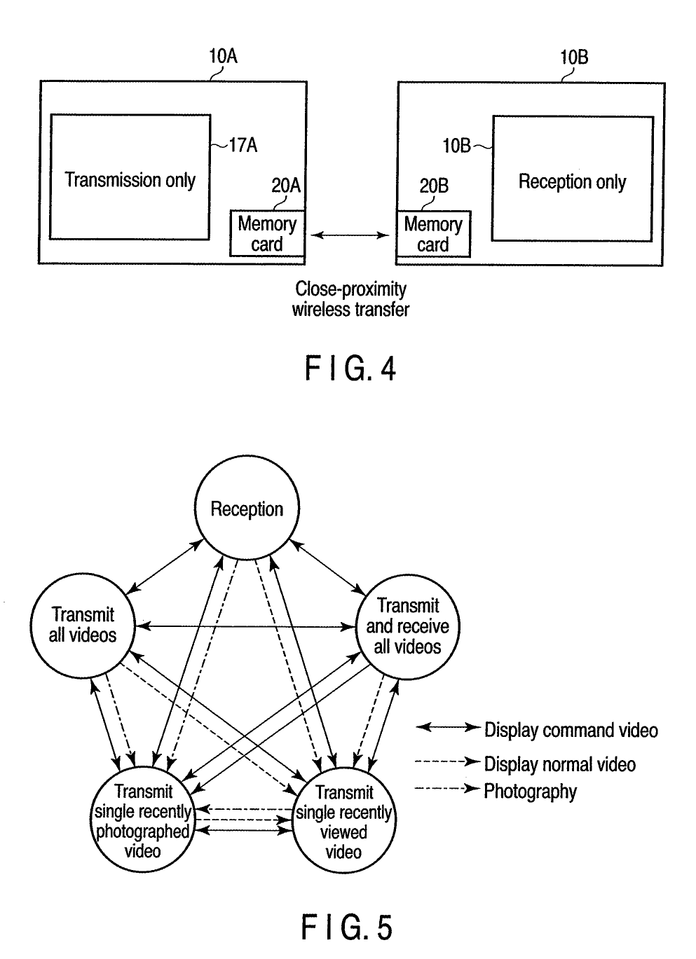

For example, besides a photograph taken by the user, a plurality of files (JPEG) of photographs showing operational contents are stored in the memory card 20 (20A and 20B). Digital cameras 10A and 10B are set in a mode in which files of photographed videos are displayed on display devices 17A and 17B. As shown in FIG. 4, when an image of a file with characters “Transmission Only” is displayed on the display device 17A, the memory card 20A is switched to a mode in which the memory card 20A performs transmission by close-proximity wireless transfer. When an image of a file with characters “Reception Only” is displayed on the display device 17B, the memory card 20B is switched to a mode in which the memory card 20B performs reception by close-proximity wireless transfer. When the receiving digital camera approaches the transmitting digital camera, the transmitting digital camera automatically starts transmitting all the photographs.

Alternatively, as shown in the transition diagram in FIG. 5, the communication mode may be selected based on a combination of a command video and any other file access. An example is shown below.

The state of the digital camera (reception, transmit all videos, transmit single recently photographed video, transmit single recently viewed video, and transmit and receive all videos)

At the time of starting the apparatus (at the time of power-on): “reception” mode

Transition
Command video display: to a mode for the contents of the photograph
Normal video display: to a “transmit single recently viewed video” mode
Photography: to a “transmit single recently photographed video” mode

The modules in the memory device execute the following processing.

[Before Communication]

(1-1) The device controller 22 passes the content of the access (read/write) and the address of a memory region to the file management module 23 (not all of the access content but a part of the access content is passed to the file management module 23).

(1-2) The file management module 23 checks which of the files corresponds to the address. If the access content and the file are changed, the file management module 23 saves the changed access content and file in the access write section as history (the file management module 23 requests the device controller 22 to transmit the relevant data and refers the transmitted data as required, in order to identify the file).

(1-3) The file management module 23 changes the communication mode and the target file according to the state transition.

[Move the Apparatuses Closer to Each Other to Allow the Apparatuses to Communicate]

(2-1) The close-proximity wireless transfer section 25 notifies the file management module 23 that wireless transfer has been enabled.

(2-2) The file management module 23 performs transmission or reception according to the communication mode.
Reception: The file management module 23 requests the device controller 22 to transmit file data and passes the received data to the close-proximity wireless transfer section, which then transmits the data to the receiving terminal.
Transmission: The file management module 23 passes the data received from the close-proximity wireless transfer section, to the device controller 22, which then writes the data to the memory card as a file.

(2-3) After the communication is completed, the file management module 23 refers the history information managed by the access write module 24, to determine the next target file.

(2-4) The close-proximity wireless transfer section 25 detects that the wireless transfer has been disabled. The flow proceeds to (1-1).

To acquire a file contained in the nonvolatile memory 21, from the device controller 22, the file management module 23 temporarily inhibits accesses to the files in the nonvolatile memory 21 via the host controller 13.

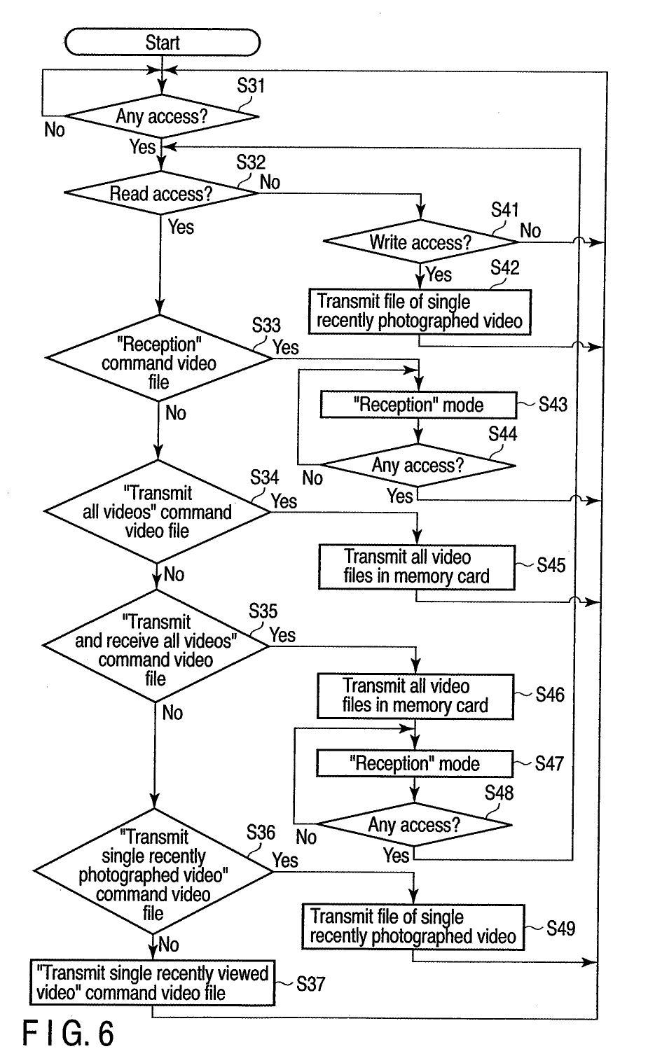

The procedure of processing for carrying out the transition shown in FIG. 5 will be described with reference to the flowchart in FIG. 6.

The file management module 23 determines whether or not the host controller 13 has accessed the nonvolatile memory (step S31). Upon determining that the host controller 13 has accessed the nonvolatile memory (Yes in step S31), the file management module 23 determines whether or not the access is a read access (step S32).

Upon determining that the access is not a read access (No in step S32), the file management module 23 determines whether or not the access is a write access (step S41). Upon determining that the access is not a write access, the file management module 23 returns to the processing in step S31. Upon determining that the access is a write access (Yes in step S41), the file management module 23 is switched to the mode in which the file management module 23 transmits a single recently photographed video. Once the close-proximity wireless transfer is enabled, the file management module 23 transmits a file of a single recently photographed video to the receiving apparatus (step S42). The procedure of the processing in this communication mode is similar to that described with reference to the flowchart in FIG. 2.

Upon determining that the access is a read access (Yes in step S32), the file management module 23 determines whether or not the target of the read access is the “reception” command video file (step S33).

Upon determining that the target is the “reception” command video file (Yes in step S33), the file management module 23 is switched to the reception mode (step S43). After being switched to the reception mode, upon determining that the host controller 13 has accessed the nonvolatile memory (Yes in step S44), the file management module 23 executes the processing step S32.

Upon determining that the target is not the “reception” command video file (No in step S33), the file management module 23 determines whether or not the target of the read access is the “transmit all videos” command video file (step S34). Upon determining that the read access is the “transmit all videos” command video file (Yes in step S34), the file management module 23 transmits all the files in the nonvolatile memory to the receiving apparatus once the close-proximity wireless transfer is enabled (step S45). The file management module 23 returns to the processing in step S31.

Upon determining that the read access is the “transmit all videos” command video file (No in step S34), the file management module 23 determines whether or not the target of the read access is the “transmit and receive all videos” command video file (step S35). Upon determining that the target of the read access is the “transmit and receive all videos” command video file (Yes in step S35), the file management module 23 transmits all the files in the nonvolatile memory to the receiving apparatus once the close-proximity wireless transfer is enabled (step S46). The file management module 23 is then switched to the reception mode (step S47). After being switched to the reception mode, upon determining that the host controller 13 has accessed the nonvolatile memory (Yes in step S48), the file management module 23 executes the processing step S32.

Upon determining that the target is not the “transmit and receive all videos” command video file (No in step S35), the file management module 23 determines whether or not the target of the read access is the “transmit a single recently photographed video” command video file (step S36). Upon determining that the target of the read access is the “transmit a single recently photographed video” command video file (Yes in step S36), the file management module 23 is switched to the communication mode in which the file management module 23 transmits a file of a single recently photographed video. Once the close-proximity wireless transfer is enabled, the file management module 23 transmits the file of the single recently photographed video (step S49). The procedure of the processing in this communication mode is similar to that described with reference to the flowchart in FIG. 2.

If the file management module 23 determines that the target of the read access is not the “transmit a single recently photographed video” command video file (No in step S36), then the host controller 13 may have accessed the “single recently viewed video” command video file or a normal file. Thus, the file management module 23 is switched to the mode in which the file management module 23 transmits a file of a single recently viewed video to the receiving apparatus. Once the close-proximity wireless transfer is enabled, the file management module 23 transmits the file of the single recently viewed video to the receiving apparatus (step S37). The procedure of the processing in this communication mode is similar to that described with reference to the flowchart in FIG. 3.

According to the memory card according to the embodiment of the present invention, the memory card 20 containing the close-proximity wireless transfer function (the memory card 20 or the like) is installed in a close-proximity wireless transfer-incompatible digital camera (or a close-proximity wireless transfer-incompatible video camera, PC, or cellular phone). Then, photographs (or motion pictures) written to the memory card 20 can be transferred to the digital camera. Furthermore, moving the memory card closer to a close-proximity wireless transfer-compatible communication apparatus enables the transfer of one file specified via the close-proximity wireless transfer section-compatible communication apparatus.

In the above-described embodiment, the digital camera is described as an electronic apparatus. However, the present invention is applicable to any other apparatus. For example, the present invention is applicable to a mobile communication apparatus such as a cellular phone.

Alternatively, in a situation in which close-proximity wireless transfer is enabled, the mode may be switched by a file access in the memory device (for example, an operation of switching the command video). This enables consecutive file transfers without the need for an operation based on the distance between the terminals (the operation of moving one of the terminals away from and closer to the other).

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A memory card configured to be installed in and removed from a card slot formed in an electronic apparatus, the memory card comprising:
a memory section configured to store at least one file;
a close-proximity wireless transfer section configured to perform close-proximity wireless transfer; and
a controller configured, every time communication between the close-proximity wireless transfer section and a different close-proximity wireless transfer device is enabled, to execute a process for using the close-proximity wireless transfer section to transmit the files stored in the memory section to the different close-proximity wireless transfer device.

2. The memory card of claim 1, further comprises an access write module configured to hold history information on read accesses from the electronic apparatus to the files stored in the memory section,
wherein controller configured, every time communication with the different close-proximity wireless transfer device is enabled, to sequentially transmit the files to the different close-proximity wireless transfer device starting with the file with latest date and time of read access based on the history information.

3. The memory card of claim 1, further comprises an access write module configured to hold history information on write accesses from the electronic apparatus to the files stored in the memory section,
wherein the controller configured, every time communication with the different close-proximity wireless transfer device is enabled, to sequentially transmit the files to the different close-proximity wireless transfer device starting with the file with latest date and time of write access based on the history information.

4. The memory card of claim 1, further comprises an access write module configured to hold history information on read accesses from the electronic apparatus to the files stored in the memory section,
wherein the memory section configured to store a command file which describes setting of a mode in which the files stored in the memory section are transmitted, and
the controller configured to identify a file subjected to last read access based on the history information, and to select a file to be transmitted according to the identified command file when the identified file is the command file.

5. The memory card of claim 4, wherein the memory section configured to store a reception command file which describes setting of a mode in which the files stored in the memory section are transmitted, and
the controller configured to execute a process for storing a file transmitted from the different close-proximity wireless transfer device in the memory section when the identified file is the reception command file.

6. A memory card configured to be installed in and removed from a card slot formed in an electronic apparatus, the memory card comprising:
a memory section configured to store at least one file;
a close-proximity wireless transfer section configured to perform close-proximity wireless transfer; and
a controller configured, every time communication between the close-proximity wireless transfer section and a different close-proximity wireless transfer device is enabled, to execute a process for storing one file received by the close-proximity wireless transfer section in the memory section.

7. A method for controlling a memory card comprising a memory section configured to store at least one file, and a close-proximity wireless transfer section configured to perform close-proximity wireless transfer, the method comprising:
executing, every time communication between the close-proximity wireless transfer section and a different close-proximity wireless transfer device is enabled, a process for transmitting one file to stored in the memory section to the different close-proximity wireless transfer device using the close-proximity wireless transfer section.

8. The method for controlling the memory card of claim 7, wherein the memory card further comprises an access write module configured to hold history information on read accesses from the electronic apparatus to the files stored in the memory section, and
the method further comprises sequentially transmitting, every time communication with the different close-proximity wireless transfer device is enabled, the files to the different close-proximity wireless transfer device starting with files with latest date and time of read access based on the history information.

9. The method for controlling the memory card of claim 7, wherein the memory card further comprises an access write module configured to hold history information on write accesses from the electronic apparatus to the files stored in the memory section, and
the memory section configured to store a command file which describes setting of a mode in which the files stored in the memory section are transmitted, and
the method further comprises identifying a file subjected to last read access based on the history information, and transmitting a file which is selected according to the identified command file when the identified file is the command file.

10. The method for controlling the memory card of claim 9, wherein the memory section configured to store a reception command file which describes setting of a mode in which the files stored in the memory section are transmitted, and
the method further comprises storing a file which is transmitted from the different close-proximity wireless transfer device in the memory section when the identified file is the reception command file.
